(19) United States
(12) Patent Application Publication
(10) Pub. No.: US 2026/0367699 A1
(43) Pub. Date: Nov. 19, 2026

(54) INTERACTIVE CONTROL SYSTEM AND INTERACTIVE CONTROL METHOD

(71) Applicant: COMPAL ELECTRONICS, INC., Taipei City (TW)

(72) Inventors: Po-Chun Liu, Taipei City (TW); Kai-Yi Chen, Taipei City (TW); Ting-Chieh Huang, Taipei City (TW); Chia-Wei Huang, Taipei City (TW); EDWIN EDWIN, Taipei City (TW); Ko-Ping Tseng, Taipei City (TW)

(73) Assignee: COMPAL ELECTRONICS, INC., Taipei City (TW)

(21) Appl. No.: 19/353,634

(22) Filed: Oct. 9, 2025

Related U.S. Application Data
(60) Provisional application No. 63/706,734, filed on Oct. 13, 2024.

(51) Int. Cl. G06F 3/01; G01P 13/00; G01S 17/08; G06V 20/62; G06V 40/10; G06V 40/20

(52) U.S. Cl. CPC G06F 3/012; G01P 13/00; G01S 17/08; G06V 40/28; G06V 20/62; G06V 40/10

(57) ABSTRACT

Embodiments of the present invention provide an interactive control system and an interactive control method. The interactive control system includes a head-mounted device, an auxiliary sensor, and a processor. The processor identifies whether motion information detected by a motion sensor of the head-mounted device corresponds to a target behavior, and obtains auxiliary information according to the target behavior through the auxiliary sensor. Next, the processor determines whether the auxiliary information corresponds to a target condition, and obtains an image to be detected through an image capture device of the head-mounted device according to the target condition. The processor identifies a target object in the image to be detected, and generates a display content of an information image according to the target object. In this way, interactive experience can be improved.

### CROSS-REFERENCE TO RELATED APPLICATION

This application claims the priority benefit of U.S. provisional application Ser. No. 63/706,734, filed on Oct. 13, 2024. The entirety of the above-mentioned patent application is hereby incorporated by reference herein and made a part of this specification.

### TECHNICAL FIELD

The present invention relates to a human-computer interaction technology, and more particularly to an interactive control method and an interactive control system.

### DESCRIPTION OF RELATED ART

The development of head-mounted devices such as smart glasses has brought users the convenience of overlaying digital information on the real world. However, conventional devices still face challenges in interactive control. Traditional activation mechanisms, such as manually touching a glasses frame or a specific voice command, may not be intuitive or may not facilitate operation in certain scenarios. For example, the user may simply be fixing their hair or adjusting their glasses and accidentally touch the touchpad or there may not be enough time to give an accurate voice command at the moment when the scene before the eyes needs to be quickly captured.

On the other hand, if the head-mounted devices rely solely on motion sensors (such as detecting when the user raises or turns their head) to trigger functions, frequent false activations may occur due to inadvertent daily motion, which not only disturbs the user but also causes unnecessary power consumption.

### SUMMARY

The present invention provides an interactive control method and an interactive control system, which may solve the issue of a head-mounted device being easily false triggered or not activated in time, and provide a more intuitive, accurate, and low-power consumption interactive experience.

An interactive control system of an embodiment of the present invention includes a head-mounted device, an auxiliary sensor, and a processor. The head-mounted device includes a motion sensor, an image capture device, and a display. The processor is communicatively connected to the head-mounted device and the auxiliary sensor. The processor is configured to: identify that motion information detected by the motion sensor corresponds to a target behavior, and obtain auxiliary information through the auxiliary sensor according to the target behavior; determine whether the auxiliary information corresponds to a target condition, and obtain an image to be detected through the image capture device according to the target condition; and identify a target object in the image to be detected, and generate a display content of an information image displayed through the display according to the target object.

An interactive control method of an embodiment of the present invention includes (but is not limited to) the following steps. A head-mounted device, an auxiliary sensor, and a processor are provided. The head-mounted device includes a motion sensor, an image capture device, and a display. Whether motion information detected by the motion sensor corresponds to a target behavior is identified through the processor, and auxiliary information is obtained according to the target behavior through the auxiliary sensor. Whether the auxiliary information corresponds to a target condition is determined through the processor, and an image to be detected is obtained through the image capture device according to the target condition. A target object in the image to be detected is identified, and a display content of an information image displayed through the display is generated according to the target object.

Based on the above, the interactive control system and the interactive control method of the embodiments of the present invention improve the accuracy of interaction through a dual-condition trigger mechanism. A first user motion (that is, the target behavior) detected by the motion sensor of the head-mounted device serves as a “pre-activation” condition, while a second condition (that is, the target condition) detected by the auxiliary sensor serves as a final confirmation trigger signal. Such judgment manner of combining the own posture of the user and external sensing information can effectively filter out simple and unconscious motions. Image capture and information display are only activated when the system is highly certain of the intention of the user, thereby solving the issues of easy accidental touch, power consumption, and slow response.

In order for the features and advantages of the present invention to be more comprehensible, the following specific embodiments are described in detail in conjunction with the drawings.

### BRIEF DESCRIPTION OF THE DRAWINGS

FIG. 1A is a block diagram of elements of an interactive control system according to an embodiment of the present invention.

FIG. 1B and FIG. 1C are schematic diagrams of an appearance of a head-mounted device according to an embodiment of the present invention.

FIG. 2A and FIG. 2B are schematic diagrams of usage scenarios of interactive control systems according to an embodiment of the present invention.

FIG. 3 is a flowchart of an interactive control method according to an embodiment of the present invention.

FIG. 4 is a flowchart of target behavior detection according to an embodiment of the present invention.

FIG. 5A to FIG. 5D are schematic diagrams of a target behavior and an information image according to an embodiment of the present invention.

FIG. 6 is a flowchart of depth detection according to an embodiment of the present invention.

FIG. 7 is a flowchart of motion detection according to an embodiment of the present invention.

FIG. 8 is a flowchart of image identification according to an embodiment of the present invention.

FIG. 9A to FIG. 9D are schematic diagrams of display contents of different application scenarios according to an embodiment of the present invention.

FIG. 10 is a schematic diagram of a display content of an information image according to an embodiment of the present invention.

FIG. 11A and FIG. 11B are schematic diagrams of an activation process of an information image according to an embodiment of the present invention.

FIG. 12 is a schematic diagram of a browsing process of an information image according to an embodiment of the present invention.

FIG. 13 is a flowchart of hand gesture control according to an embodiment of the present invention.

FIG. 14 is a schematic diagram of a reference hand gesture according to an embodiment of the present invention.

FIG. 15A and FIG. 15B are schematic diagrams of a user interface according to an embodiment of the present invention.

FIG. 16 and FIG. 17 are schematic diagrams of derived information according to an embodiment of the present invention.

FIG. 18A to FIG. 18D are schematic diagrams of another interaction process according to an embodiment of the present invention.

FIG. 19A to FIG. 19C are schematic diagrams of another interaction process according to an embodiment of the present invention.

FIG. 20A and FIG. 20B are schematic diagrams of a target object and a corresponding display content according to an embodiment of the present invention.

FIG. 21A and FIG. 21B are schematic diagrams of another interaction process according to an embodiment of the present invention.

### DESCRIPTION OF THE EMBODIMENTS

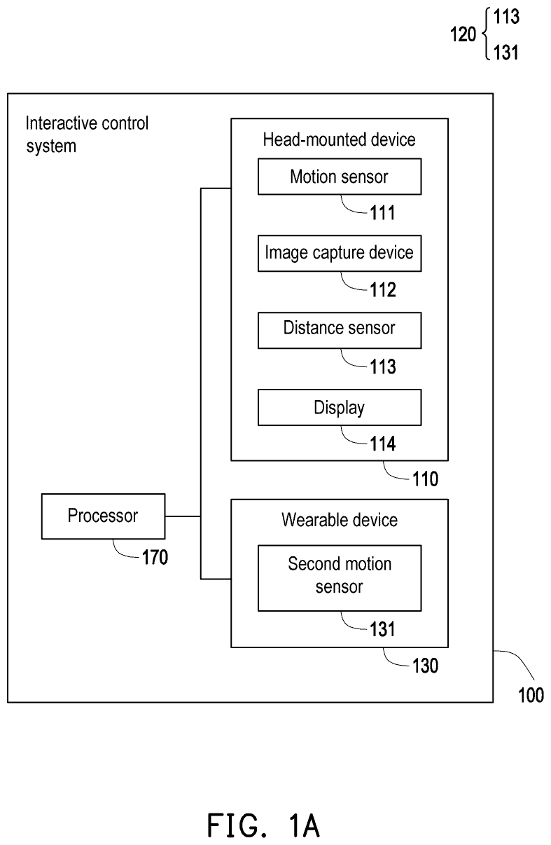

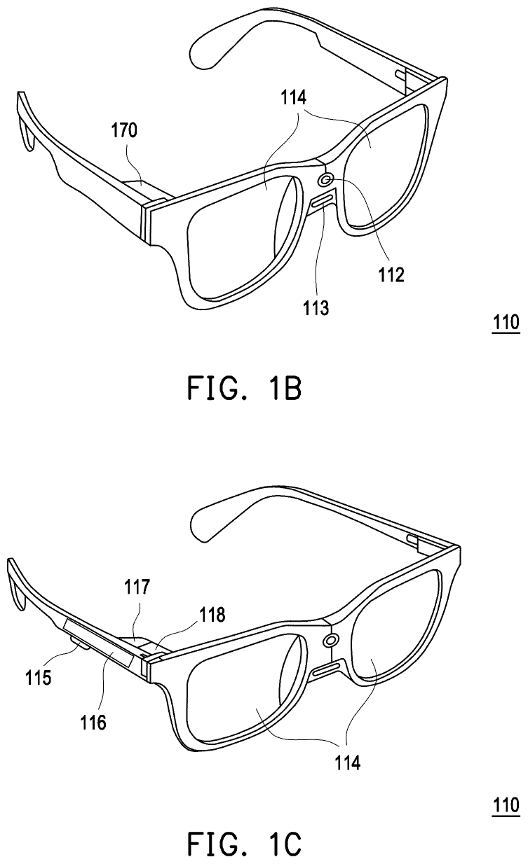

FIG. 1A is a block diagram of elements of an interactive control system 100 according to an embodiment of the present invention. Please refer to FIG. 1A. The interactive control system 100 includes (but is not limited to) a head-mounted device 110, an auxiliary sensor 120, and a processor 170.

The head-mounted device 110 is, for example, a head-mounted display, smart glasses, or a virtual reality device. The head-mounted device 110 includes (but is not limited to) a motion sensor 111, an image capture device 112, a distance sensor 113, and a display 114.

FIG. 1B and FIG. 1C are schematic diagrams of an appearance of the head-mounted device 110 (taking the smart glasses as an example) according to an embodiment of the present invention. Please refer to FIG. 1A, FIG. 1B, and FIG. 1C. The motion sensor 111 may be a gravity sensor (G-sensor), an accelerometer, a magnetic sensor, a gyroscope, an inertial measurement unit (IMU), or a combination of the above elements. In an embodiment, the motion sensor 111 is used to measure a physical state (posture or orientation) of the head-mounted device 110 in a three-dimensional space and output motion information. The motion information may be, for example, an acceleration vector generated by the accelerometer, an angular velocity generated by the gyroscope, a magnetic field vector generated by the magnetic sensor, or comprehensive measurement data generated by the IMU.

The image capture device 112 is, for example, a red-green-blue (RGB) video camera/camera. In an embodiment, the image capture device 112 is used to capture a designated environment and generate an image to be detected. That is, the image to be detected is an image generated by captured ambient light. The field of view before the glasses is captured as shown in FIG. 1B. The image capture device 112, for example, captures multiple complete images to be measured at a fixed frame rate. The images to be measured may be used to identify visual/image features such as color, texture, and shape of a target object (for example, a user or a body part such as head, hand, or torso of the user) in an environment.

The distance sensor 113 may be a proximity sensor, an infrared sensor, a lidar, or a radar. In an embodiment, the distance sensor 113 is used to detect distance information between the head-mounted device 110 and a wearable device 130. The distance information indicates a distance value between the head-mounted device 110 and the wearable device 130.

The display 114 may be an LCD, an LED display, an OLED display, or an electronic paper display. In an embodiment, the display 114 is used to display an image.

The head-mounted device 110 may provide an input device for receiving a user command. Please refer to FIG. 1C. In an embodiment, the head-mounted device 110 may further include a power switch 115. The power switch 115 is used to receive a pressing operation of the user and turn on or off the display 114 accordingly.

In an embodiment, the head-mounted device 110 may further include a touch panel 116. The touch panel 116 is used to receive a touch operation of the user, such as a pressing, swiping, or tapping operation. The touch operation is used to, for example, trigger photo taking (corresponding to the pressing operation), face search (corresponding to a long pressing operation), left operation (corresponding to a left swiping operation), right operation (corresponding to a right swiping operation), selection operation (corresponding to a tapping operation), returning to the home page or return operation (corresponding to a double tapping operation), or activating a microphone module (not shown) for a recording task to receive a voice command (corresponding to a long pressing operation).

In an embodiment, the head-mounted device 110 may further include buttons 117 and 118. The buttons 117 and 118 may receive a pressing operation of the user. The buttons 117 and 118 may be preset or customized to trigger specific functions or application programs of the head-mounted device 110, such as work schedule, message, stop, shopping list, or traffic information.

Please refer to FIG. 1A. The auxiliary sensor 120 includes the distance sensor 113 and a second motion sensor 131 of the wearable device 130. In an embodiment, the auxiliary sensor 120 is used to detect auxiliary information. The auxiliary information is, for example, distance information of the distance sensor 113. Alternatively, the auxiliary information is, for example, second motion information (which will be described later) of the second motion sensor 131.

The processor 170 is communicatively connected to the head-mounted device 110 and the auxiliary sensor 120, such as through Wi-Fi, Bluetooth, or other wireless communication technologies. One or more processors 170 may be smartphones, tablet computers, and/or processors of the head-mounted device 110. The processor 170 may be a central processing unit (CPU), other programmable general-purpose or specific-purpose microprocessors, digital signal processors (DSP), programmable controllers, application-specific integrated circuits (ASIC), other similar elements, or a combination of the above elements. In some embodiments, some functions of the processor 170 may be implemented on multiple devices.

In an embodiment, the interactive control system 100 may further include the wearable device 130. The wearable device 130 is communicatively connected to the head-mounted device 110 and the processor 170, such as through Wi-Fi, Bluetooth, or other communication technologies. The wearable device 130 is, for example, a smart watch, a smart wristband, a smart ring, or a smart bracelet and is worn on a wrist of the user. The wearable device 130 includes (but is not limited to) the second motion sensor 131.

Reference may be made to the above description of the motion sensor 111 for the implementation and the function of the second motion sensor 131, which will not be repeated here. In an embodiment, the second motion sensor 131 is used to measure a physical state (posture or orientation) of the wearable device 130 in a three-dimensional space and output second motion information. The second motion information is, for example, the acceleration vector generated by the accelerometer, the angular velocity generated by the gyroscope, the magnetic field vector generated by the magnetic sensor, or the comprehensive measurement data generated by the IMU.

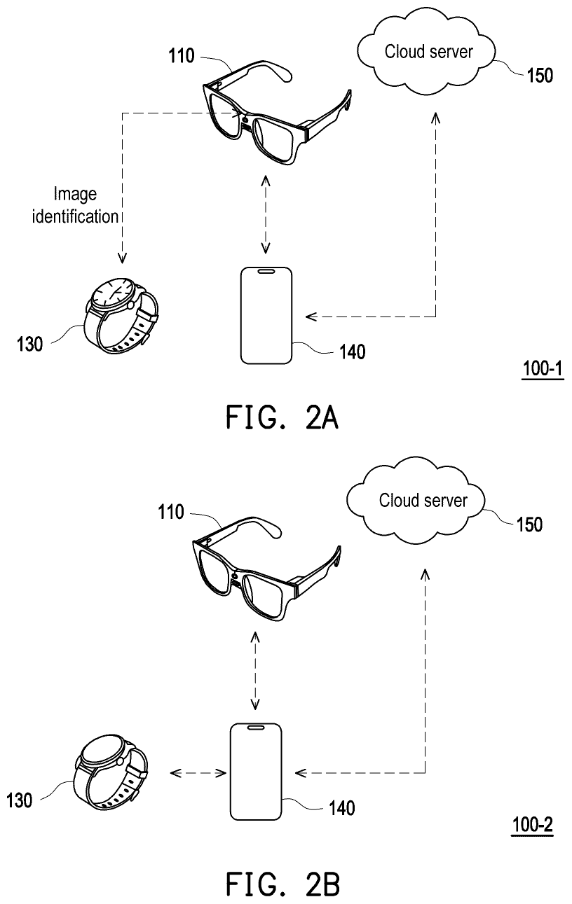

FIG. 2A and FIG. 2B are schematic diagrams of usage scenarios of interactive control systems 100-1 and 100-2 according to an embodiment of the present invention. Please refer to FIG. 2A. The interactive control system 100-1 includes a head-mounted device 110, a general watch 135 (for example, a non-smart watch), a smartphone 140, and a cloud server 150. The head-mounted device 110 is connected to the smartphone 140 through Bluetooth, and the smartphone 140 may be connected to the cloud server 150 through mobile communication (for example, 2G, 3G, 4G, or 5G mobile communication). The cloud server 150 may run an artificial intelligence model. In addition, the head-mounted device 110 may perform image identification on an image obtained by capturing the general watch 130.

Please refer to FIG. 2B. The interactive control system 100-2 includes the head-mounted device 110, the wearable device 130 (taking the smart watch as an example), the smartphone 140, and the cloud server 150. The head-mounted device 110, the wearable device 130, and the smartphone 140 may be connected through Bluetooth, and the smartphone 140 may be connected to the cloud server through mobile communication (for example, 2G, 3G, 4G, or 5G mobile communication).

Hereinafter, the method according to the embodiment of the present invention will be described with reference to devices, elements, or modules in FIG. 1 to FIG. 2B. Each process of the method may be adjusted according to the implementation situation and is not limited here.

One or more key concepts of the embodiment of the present invention are as follows. Based on the natural behavior of raising the hand and looking at the watch of the user, when the user does the motion, the head-mounted device 110 simultaneously displays a corresponding information interface to provide the user with visual information, and through the coordination of the auxiliary sensor 120 and the image capture device 112, other motions are prevented from accidentally activating the head-mounted device 110. The following will be described in detail through multiple embodiments.

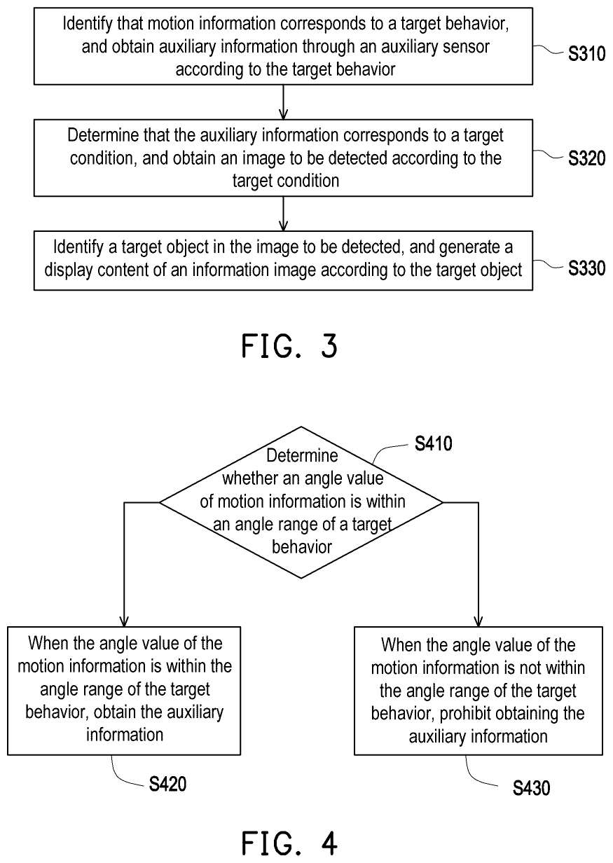

FIG. 3 is a flowchart of an interactive control method according to an embodiment of the present invention. Please refer to FIG. 3. The processor 170 identifies that motion information corresponds to a target behavior, and obtains auxiliary information through the auxiliary sensor 120 according to the target behavior (step S310). Specifically, the motion information represents the posture or the orientation of the head-mounted device 110 or the head wearing the head-mounted device 110 in a three-dimensional space. The pose or the orientation may correspond to a specific position, and the position is quantified as an angle value.

On the other hand, the target behavior corresponds to a specific motion/behavior of the head-mounted device 110 or the head wearing the head-mounted device 110. In an embodiment, the target behavior is a head lowering behavior, such as a continuous motion of the head lowering from forward to downward. Generally speaking, when the user raises the hand to look at the watch on the wrist, the head lowering behavior occurs. Therefore, the processor 170 detects the head lowering behavior.

FIG. 4 is a flowchart of target behavior detection according to an embodiment of the present invention. Please refer to FIG. 4. The processor 170 may determine whether the angle value of the motion information is within an angle range of the target behavior (step S410). Specifically, the angle range of the target behavior is, for example, 15 to 45, 20 to 40, or 10 to 35 degrees relative to a front view orientation of the head, but may be changed according to design requirements. The processor 170 converts the motion information into the angle value (for example, through formula conversion, a lookup table, or artificial intelligence model inference), and compares the angle value with the angle range of the target behavior.

When the angle value of the motion information is within the angle range of the target behavior, the processor 170 may obtain the auxiliary information through the auxiliary sensor 120 (step S420). For example, the angle value corresponding to the motion information measured by the motion sensor 111 is 35 degrees relative to a reference direction (that is, the front view orientation of the head), and 35 degrees is within the angle range of 15 to 45 degrees. Therefore, the processor 170 sends an auxiliary request command to the auxiliary sensor 120 (for example, the distance sensor 113 of the head-mounted device 110 and/or the second motion sensor 131 of the wearable device 130), so that the auxiliary sensor 120 executes a measurement task and send the auxiliary information to the processor 170.

On the other hand, when the angle value of the motion information is not within the angle range of the target behavior, the processor 170 may prohibit obtaining the auxiliary information (step S430). For example, the angle value corresponding to the motion information measured by the motion sensor 111 is 10 degrees relative to the reference direction (that is, the front view orientation of the head), and 10 degrees is not within the angle range of 20 to 50 degrees. Therefore, the processor 170 prohibits/does not send the auxiliary request command to the auxiliary sensor 120 (for example, the distance sensor 113 of the head-mounted device 110 and/or the second motion sensor 131 of the wearable device 130), so that the auxiliary sensor 120 does not execute the measurement task or does not send the auxiliary information, and the processor 170 cannot obtain the auxiliary information.

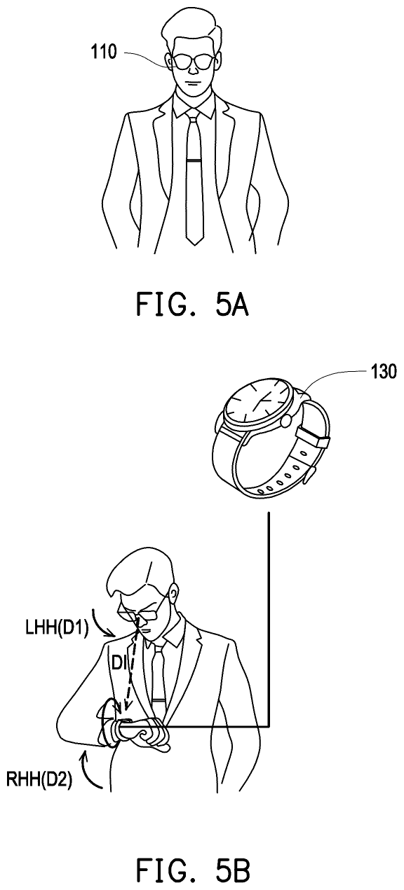

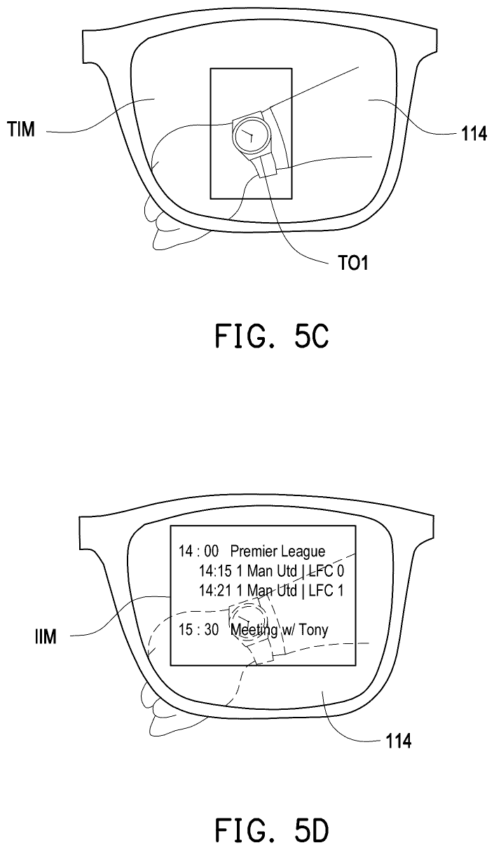

For example, FIG. 5A to FIG. 5D are schematic diagrams of a target behavior and an information image according to an embodiment of the present invention. Please refer to FIG. 5A. The user wears the head-mounted device 110 (taking the smart glasses as an example). Please refer to FIG. 5B. The head-mounted device 110 first detects a head lowering behavior LHH. The motion sensor 111 measures the head lowering behavior LHH, and the processor 170 determines that an angle value DI corresponding to the measured motion information is within the angle range corresponding to the head lowering behavior LHH.

Please refer to FIG. 3. The processor 170 determines that the auxiliary information corresponds to a target condition, and obtains an image to be detected according to the target condition (step S320). Specifically, the target condition is related to a continuous motion of turning the wrist and/or raising the hand of the user. Generally speaking, when the user intends to look at the watch, the user turns the wrist and/or raises the hand, so that the eyes may look directly at the face of the watch.

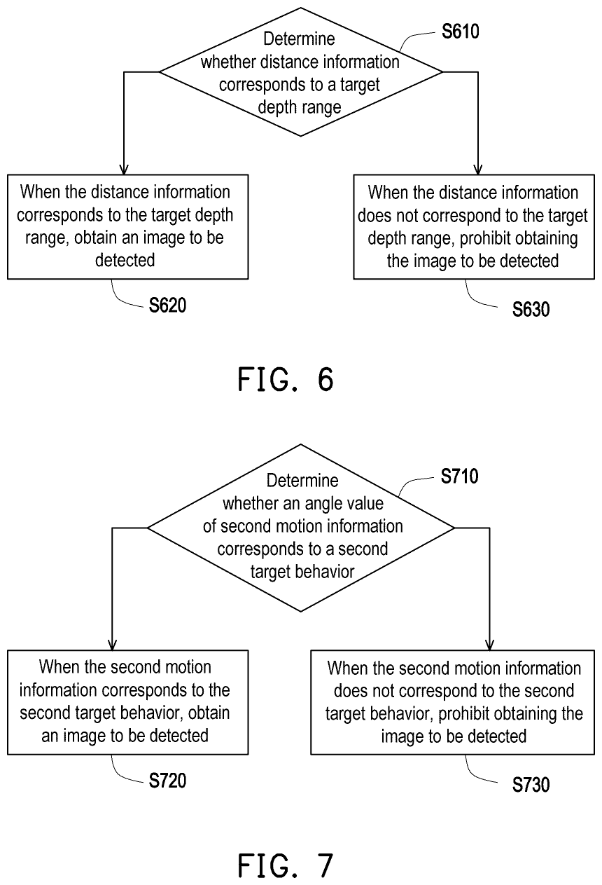

FIG. 6 is a flowchart of depth detection according to an embodiment of the present invention. Please refer to FIG. 6. The auxiliary sensor 120 is the distance sensor 113 of the head-mounted device 110. The embodiment is adapted to the usage scenarios of FIG. 2A and FIG. 2B. At this time, the auxiliary information is the distance information (representing the distance/depth value of the target object, such as the wearable device 130 or other general watches, relative to the head-mounted device 110), and the target condition is a target depth range. The target depth range corresponds to the distance/depth range, such as 35 to 60 cm, 20 to 50 cm, or 15 to 60 cm, which may be changed according to design requirements, of the wearable device 130 or other general watches relative to the head (for example, the eyes or the forehead) during the process of the continuous motion of turning the wrist and/or raising the hand.

The processor 170 may determine whether the distance information corresponds to the target depth range (step S610). Specifically, the processor 170 converts the distance information into a depth/distance value (for example, through formula conversion, a lookup table, or artificial intelligence model inference), and compares the depth/distance value with the target depth range of the target condition.

When the distance information corresponds to the target depth range, the processor 170 may obtain the image to be detected through the image capture device 112 (step S620). For example, the distance information (for example, a sensing intensity value or a round-trip time) measured by the distance sensor 113 corresponds to the depth/distance value of 40 cm, and 40 cm is within the target depth range of 35 to 45 cm. Therefore, the processor 170 sends an identification request command to the image capture device 112 of the head-mounted device 110, so that the image capture device 112 sends the image to be detected to the processor 170.

On the other hand, when the distance information does not correspond to the target depth range, the processor 170 may prohibit obtaining the image to be detected obtained by the image capture device 112 (step S630). For example, the distance information (for example, the sensing intensity value or the round-trip time) measured by the distance sensor 113 corresponds to the depth/distance value of 60 cm, and 60 cm is not within the target depth range of 20 to 50 cm. Therefore, the processor 170 prohibits/does not send the identification request command to the image capture device 112 of the head-mounted device 110, so that the image capture device 112 prohibits/does not send the image to be detected to the processor 170, and the processor 170 cannot obtain the image to be detected or ignores the image to be detected.

Taking FIG. 5B as an example, the head-mounted device 110 detects a behavior RHH corresponding to turning the wrist and/or raising the hand. The distance sensor 113 measures the behavior RHH, and the processor 170 determines whether a depth/distance value DI corresponding to the measured distance information is within the target depth range corresponding to the behavior RHH. Please refer to FIG. 5C. The image capture device 112 obtains an image to be detected TIM.

FIG. 7 is a flowchart of motion detection according to an embodiment of the present invention. Please refer to FIG. 7. The auxiliary sensor 120 is the second motion sensor 131 of the wearable device 130. The embodiment is adapted to the usage scenario of FIG. 2B. At this time, the auxiliary information is the second motion information (the posture or the orientation of the wearable device 130 in a three-dimensional space), and the target condition is a second target behavior. For example, the second target behavior corresponds to the continuous motion of turning the wrist and/or raising the hand. The second target behavior corresponds to a rotation range, such as 85 to 100 degrees or 90 to 105 degrees, which may be changed according to design requirements, of the wearable device 130 relative to the reference direction (for example, the front view orientation of the glasses) during the process of the continuous motion of turning the wrist and/or raising the hand.

The processor 170 may determine whether the second motion information corresponds to the second target behavior (step S710). Specifically, the processor 170 converts the second motion information into the angle value (for example, through formula conversion, a lookup table, or artificial intelligence model inference), and compares the angle value with the rotation range of the second target behavior.

In an embodiment, the processor 170 may determine whether the angle value of the second motion information (for example, gravitational acceleration, magnetic force, or angular velocity) is within the rotation range of the second target behavior.

When the second motion information corresponds to the second target behavior, the processor 170 may obtain the image to be detected through the image capture device 112 (step S720). For example, the angle value corresponding to the second motion information (for example, gravitational acceleration, magnetic force, or angular velocity) measured by the second motion sensor 131 is 92 degrees relative to the reference direction, and 92 degrees is within the rotation range of 90 to 100 degrees. Therefore, the processor 170 sends the identification request command to the image capture device 112 of the head-mounted device 110, so that the image capture device 112 sends the image to be detected to the processor 170.

On the other hand, when the second motion information does not correspond to the second target behavior, the processor 170 may prohibit obtaining the image to be detected obtained by the image capture device 112 (step S730). For example, the angle value corresponding to the second motion information (for example, gravitational acceleration, magnetic force, or angular velocity) measured by the second motion sensor 131 is 5 degrees relative to the reference direction, and 5 degrees is not within the rotation range of 95 to 110 degrees. Therefore, the processor 170 prohibits/does not send the identification request command to the image capture device 112 of the head-mounted device 110, so that the image capture device 112 prohibits/does not send the image to be detected to the processor 170, and the processor 170 cannot obtain the image to be detected or ignores the image to be detected.

Taking FIG. 5B as an example, the wearable device 130 detects the behavior RHH corresponding to turning the wrist and/or raising the hand. The second motion sensor 131 measures the behavior RHH, and the processor 170 determines that an angle value D2 corresponding to the measured second motion information is within the rotation range corresponding to the behavior RHH. Please refer to FIG. 5C. The image capture device 112 obtains the image to be detected TIM.

Please refer to FIG. 3. The processor 170 identifies the target object in the image to be detected, and generates a display content of the information image according to the target object (step S330). Specifically, the target object may be the wearable device 130, the general watch, the hand of the user, a smartphone, a computer, medicine, kitchenware, or any predefined identifiable object.

Identification of target object may be based on object detection technology. For example, the processor 170 may implement object detection by applying a neural network-based algorithm (for example, you only look once (YOLO), a region-based convolutional neural network (R-CNN), or a fast CNN), a feature matching-based algorithm (for example, histogram of oriented gradient (HOG), scale-invariant feature transform (SIFT), HAR, or feature matching of speeded up robust features (SURF)), or a computer vision algorithm based on surface color information. The processor 170 may judge whether the type of the object in the image to be detected is a preset target object.

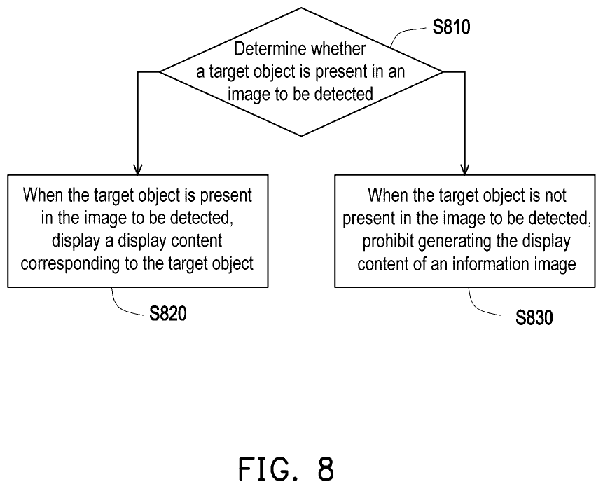

FIG. 8 is a flowchart of image identification according to an embodiment of the present invention. Please refer to FIG. 8. The processor 170 may determine whether the target object is present in the image to be detected (step S810). Specifically, the processor 170 may judge through image identification technology (for example, reference template matching, feature point comparison, or an object detection model based on deep learning). When the target object is present in the image to be detected, the processor 170 may generate and display the display content corresponding to the target object through the display 114 (step S820). On the other hand, when the target object is not present in the image to be detected, for example, the image is blurred or an unexpected object is captured, the processor 170 may prohibit/not generate the display content of the information image to prevent presenting irrelevant information (step S830).

Taking FIG. 5C as an example, a target object TO1 (taking the watch or the wearable device 130 of FIG. 5B as an example) is present in the image to be detected TIM. The display 114 may display the display content of an information image IIM.

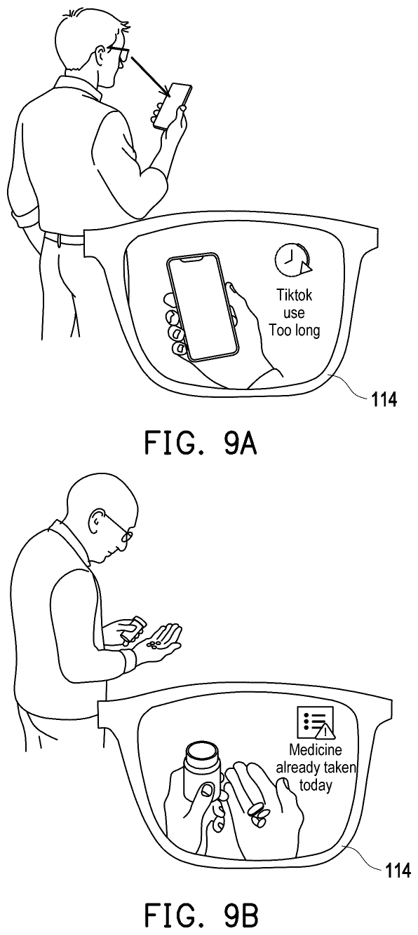

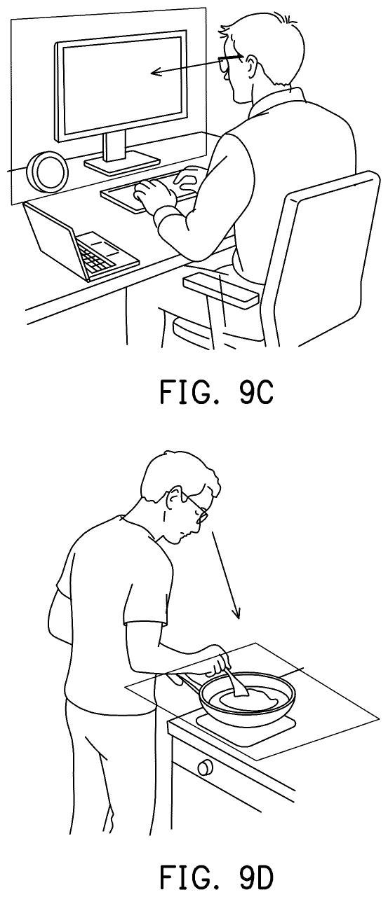

Display of the display content of the information image may change depending on design and/or application requirements. For example, FIG. 9A to FIG. 9D are schematic diagrams of display contents of different application scenarios according to an embodiment of the present invention. Please refer to FIG. 9A. The processor 170 detects that the user lowers the head and holds a mobile phone (that is, the target object). The head-mounted device 110 may be connected to an application program of the mobile phone system. The display 114 of the head-mounted device 110 displays information related to a current mobile phone activity, such as a mobile phone usage reminder and music lyrics.

Please refer to FIG. 9B. The processor 170 detects that the user lowers the head and holds a medicine box (that is, the target object). The display 114 of the head-mounted device 110 shows a medication schedule of today. In addition, the processor 170 may compare with the record to confirm, and provide more detailed information display or voice broadcast, which is helpful for elderly people with forgetfulness and poor vision.

Please refer to FIG. 9C. The processor 170 detects a studio environment (for example, the computer is the target object). The head-mounted device 110 switches to a working mode. The display 114 displays a widget customized by the user, such as meetings, calendar, and/or stocks.

Please refer to FIG. 9D. The processor 170 detects a table surface and a hand motion (that is, the target object). The head-mounted device 110 switches to a cooking mode. The display 114 displays an application program customized by the user, such as cooking timer, recipe notes, and/or nutritional measurements.

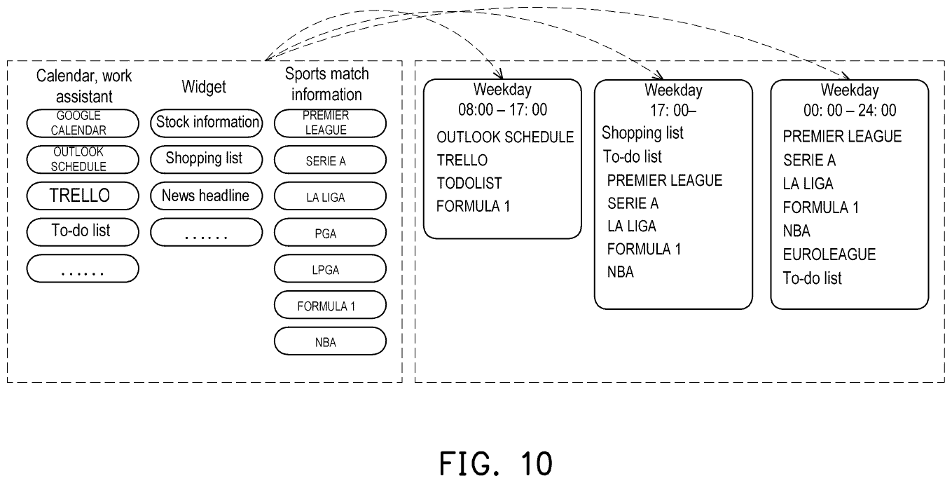

When the target object is the wearable device 130 or the general watch, the processor 170 may identify that this is a scenario of “querying time” or “querying personal information”. In an embodiment, the display content of the information image is one of calendar information, match information, to-do information, and stock information. For example, FIG. 10 is a schematic diagram of a display content of an information image according to an embodiment of the present invention. Please refer to FIG. 10. The calendar information may include a calendar content, a work schedule, or a to-do item. The widget is, for example, stock information, a shopping list, or a news headline. The match information may be related to, for example, baseball, football, racing, or basketball. The display contents correspond to the application programs of the connected wearable device 130 or other mobile devices (for example, smartphones or tablet computers). The wearable device 130 or other mobile devices may receive a selection operation of the user for a specific display content, so that the display 114 presents the display content corresponding to the selection operation, such as the calendar, the widget, and the match information corresponding to a specific time period.

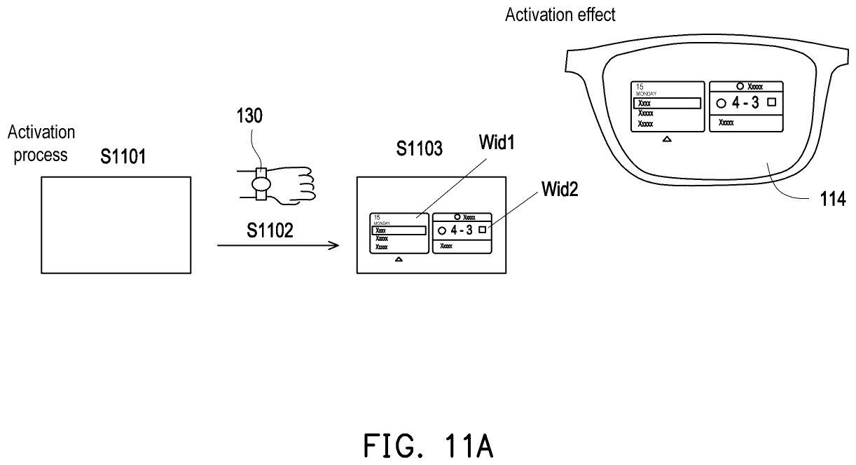

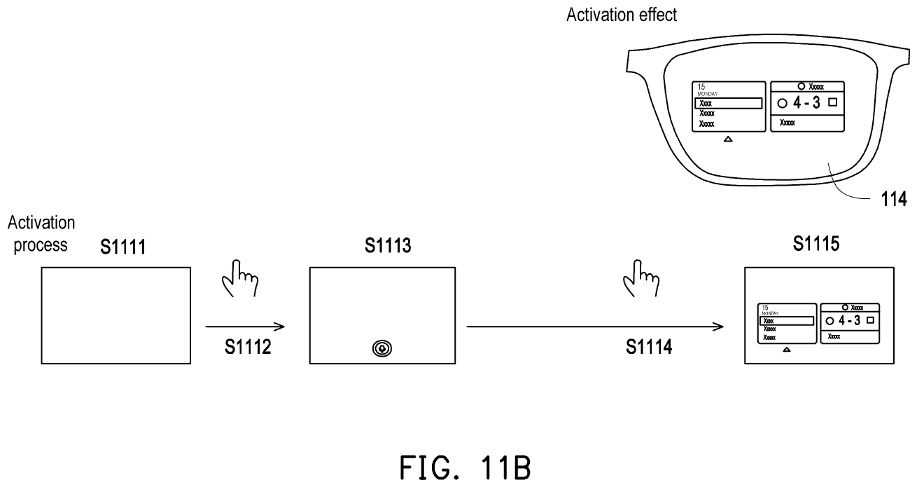

FIG. 11A and FIG. 11B are schematic diagrams of an activation process of an information image according to an embodiment of the present invention. Please refer to FIG. 11A. The embodiment illustrates how to activate the display of the information image through combining a head gesture and a hand motion. The display 114 of the head-mounted device 110 may be initially in a standby state (step S1101). For example, the screen is turned off or the brightness is low to save power.

When the user does the motion of “raising the hand and lowering the head” (step S1102), the motion combines the head lowering behavior and the behavior of raising the wrist wearing the wearable device 130 (for example, the smart watch). The motion sensor 111 of the head-mounted device 110 detects the motion information of the head lowering behavior, the second motion sensor 131 of the wearable device 130 also detects the second motion information of raising the hand, and the processor 170 analyzes the image to be detected within the field of view captured by the image capture device 112.

When the processor 170 judges that the combined motion meets a preset target behavior and target condition and there is the target object in the image to be detected, the display of the information image is triggered. Finally, the display 114 is activated and displays a corresponding widget content (that is, the display content of the information image) (step S1103), such as schedule, match, stock, shopping list, or traffic information. A widget Wid1 shown on the display 114 in the drawing is a widget of a schedule, and a widget Wid2 is a widget of a sports match.

Please refer to FIG. 11B. The embodiment illustrates of activation through a voice command. The display 114 may be in a home state (step S1111), displaying basic information such as time and battery level. The user may activate a listening mode through long pressing the touch panel 116 on the head-mounted device 110 (step S1112). In the listening mode, the microphone module of the head-mounted device 110 receives the voice command of the user (step S1113). For example, the user may say a keyword such as “instant widget”, “start instant widget” “open instant widget”, or “open widget.” After the processor 170 identifies a valid voice command, after the user releases the touch panel 116 (step S1114), a corresponding widget content is triggered and displayed on the display 114 (step S1115).

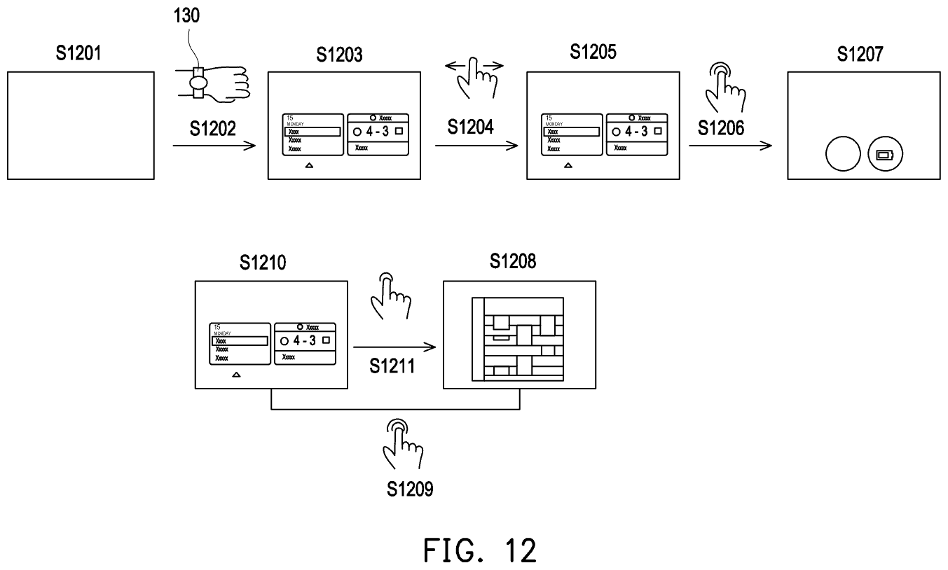

FIG. 12 is a schematic diagram of a browsing process of an information image according to an embodiment of the present invention. Please refer to FIG. 12. The display 114 of the head-mounted device 110 may be initially in the standby state (step S1201). When the user does the motion of “raising the hand and lowering the head” (step S1202), the processor 170 analyzes the image to be detected within the field of view captured by the image capture device 112. When the processor 170 judges that the combined motion meets the preset target behavior and target condition and there is the target object in the image to be detected, the display of the information image is triggered. For example, the display 114 is activated and displays the corresponding widget content (step S1203). After the information image (widget) is activated, the user may further interact with the information image. For example, in a show widget state, the user may browse different widgets through swiping left or right on the touch panel 116 of the head-mounted device 110 (step S1205). The information image, for example, switches from the screen displaying the schedule and the match information to the screen displaying the match and stock information. The user may double tap the touch panel 116 while browsing the widget (step S1206) to turn off the information image and return to the home screen (step S1207).

Alternatively, the user may double tap the touch panel 116 (step S1209) while browsing the calendar (step S1208) to switch to a widget page (step S1210). To return to the calendar browsing screen on the previous page, the user may double tap the touch panel 116 again (step S1211) to return to the calendar screen (step S1208).

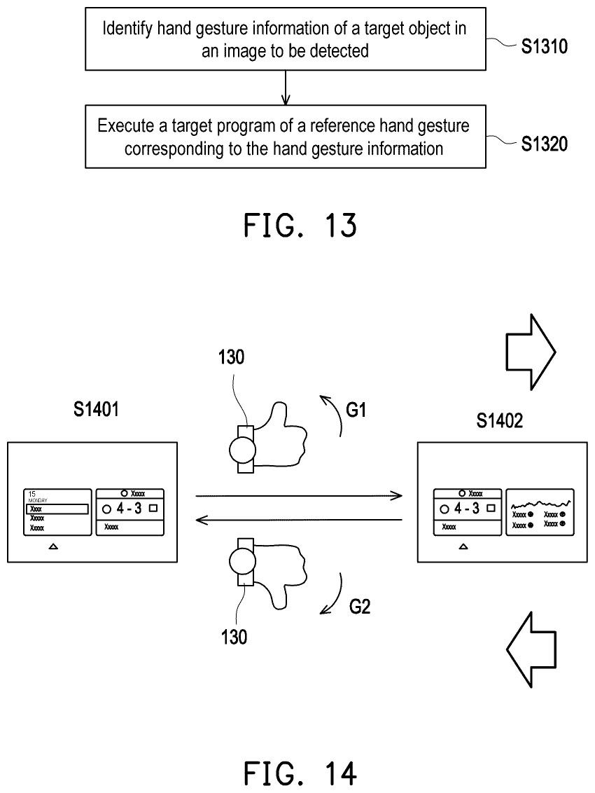

FIG. 13 is a flowchart of hand gesture control according to an embodiment of the present invention. Please refer to FIG. 13. The processor 170 identifies hand gesture information of the target object in the image to be detected (step S1310). At this time, the target object is the hand. The hand gesture information is, for example, the skeletal shape, the joint/part position, and/or the length and the orientation of joint linkage of the hand.

After identifying the hand gesture information, the processor 170 may then execute a target program of a reference hand gesture corresponding to the hand gesture information (step S1320). FIG. 14 is a schematic diagram of a reference hand gesture according to an embodiment of the present invention. As shown in FIG. 14, the user may browse the next widget through a thumbs-up hand gesture G1 or browse the previous widget through a thumbs-down hand gesture G2 (steps S1401 and S1402).

In an embodiment, the target program may be schedule browsing, missed call browsing, unread message browsing, etc., so that the user may perform information interaction with a more intuitive hand gesture. The reference hand gesture may be clenching the fist, extending the thumb and the little finger, and extending the index finger and may be changed according to actual requirements.

For example, when the processor 170 identifies a watch image and a fist clenching hand gesture from the image to be detected, the display 114 may display a time schedule. When the processor 170 identifies the watch image and the thumb and little finger extended hand gesture from the image to be detected, the display 114 may display a call interface. When the processor 170 identifies the watch image and the thumb and index finger extended hand gesture from the image to be detected, the display 114 may display the call interface.

It should be noted that the contents of the reference hand gesture and the corresponding target program may be customized according to actual requirements and are not limited in the embodiment of the present invention.

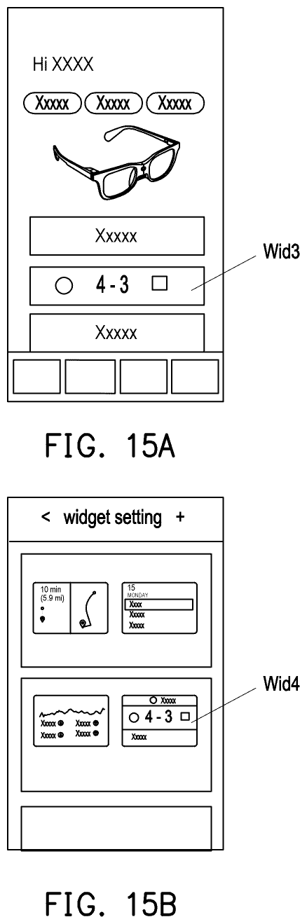

The wearable device 130 itself may also be linked with the head-mounted device 110 or other mobile devices (for example, smartphones or tablet computers). The user may configure settings on the screen of the smartphone to select which widgets to display on the head-mounted device 110. FIG. 15A and FIG. 15B are schematic diagrams of a user interface according to an embodiment of the present invention. FIG. 15A and FIG. 15B respectively present a widget Wid3 of a match state and provide a menu of a widget Wid4.

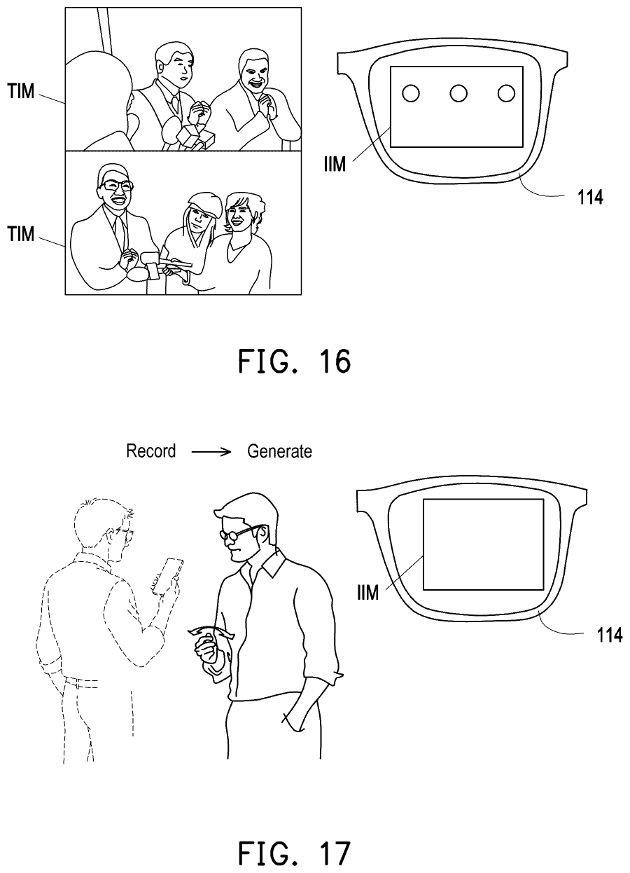

In an embodiment, the information image may include derived information. For example, FIG. 16 and FIG. 17 are schematic diagrams of derived information according to an embodiment of the present invention. Please refer to FIG. 16 and FIG. 17. In the scenario, the processor 170 may identify a target person in the image to be detected (for example, through facial identification), and generate a transcript and the derived information for conversation suggestions according to the target person and voice data (for example, a live conversation recorded through the microphone module). As shown in FIG. 17, when the user meets with a client, the display 114 may display the profile (for example, name, title, or professional experience), a past conversation summary, and feasible chat topic suggestions of the client, and may even combine voice input to instantly generate reply suggestions through an artificial intelligence module.

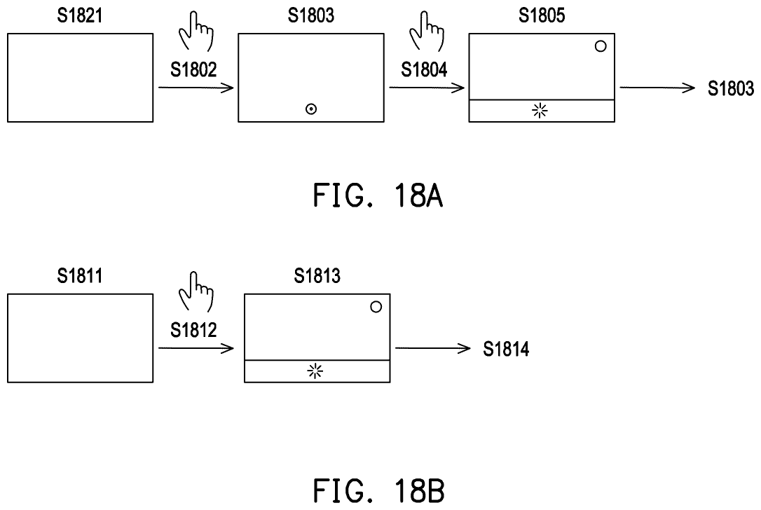

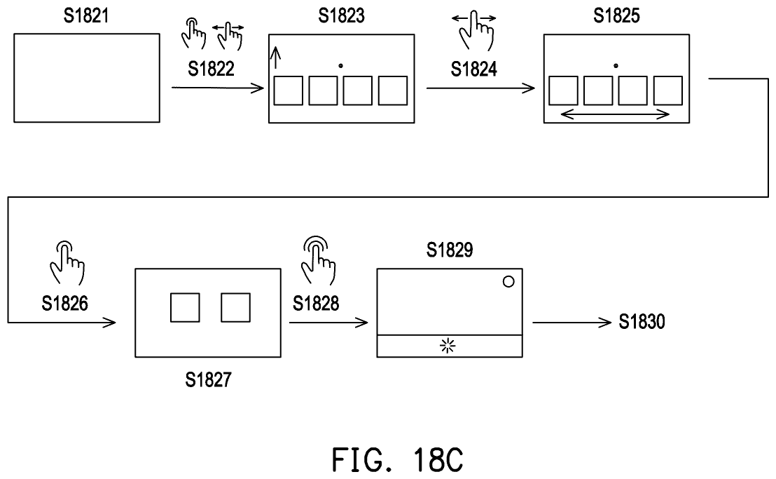

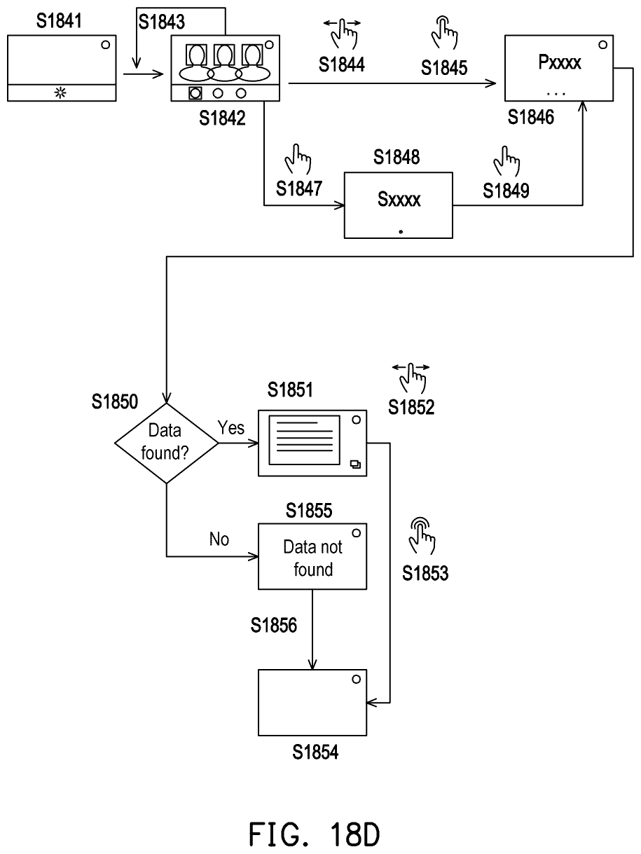

FIG. 18A to FIG. 18D are schematic diagrams of another interaction process according to an embodiment of the present invention. Please refer to FIG. 18A. The process shows activation through voice. First, when the display 114 is in the home state (step S1801), the user may long press the touch panel 116 on the head-mounted device 110 (step S1802), so that the system enters the listening mode (step S1803). In the mode, the user may speak a voice command, such as “take a look and tell me who she is”. After receiving the command and the user releases the touch panel 116 (step S1804), the processor 170 is activated and enters an application program of face search (step S1805), and then performs face detection (step S1806).

Please refer to FIG. 18B. The process shows activation through another operation. Similarly, when the display 114 is in the home state (step S1811), the user may long press a button (for example, a button 117) corresponding to photo taking (step S1812). The operation triggers the processor 170 to activate and enter an application program or a mode of face search (step S1813), and then perform face detection (step S1814).

Please refer to FIG. 18C. The process shows another manner of activating a face search function through a multi-layer touch operation. In the home state (step S1821), the user may call a function menu (step S1823) through tapping or other preset hand gestures (for example, swiping left or right) (step S1822). In the menu, the user may select a “friend memo” option through swiping or tapping (steps S1824 and S1825). After entering the friend memo interface (step S1826), the user may further select the “face search” function through the tapping hand gesture (steps S1827 and S1828). Then, the face search mode is also entered (step S1829), and then face detection is performed (step S1830).

Please refer to FIG. 18D. The process illustrates in detail the specific operation steps after entering the face search mode. Regardless of which of the above manners is used to enter the face search mode (step S1841), the processor 170 drives the image capture device 112 to start to perform face detection (step S1842). The processor 170 continuously analyzes the image to be detected, and labels one or more detected faces on the display 114 by means of a bounding box, etc., while assigning a number (step S1843) for the user to select.

After detecting a face, the user may select the target through two manners. The first manner is touch selection. The user may browse and select with touch (step S1845) the corresponding bounding box through swiping left or right (step S1844) on the touch panel 116 on the head-mounted device 110. After receiving an operation command for a specific bounding box or face by the user, the processor 170 requests the cloud server 150 to process a corresponding request (step S1846). The second manner is voice selection. The user may activate the listening mode through long pressing the touch panel 116 on the head-mounted device 110 (step S1847). In the listening mode, the microphone module of the head-mounted device 110 receives a voice command, such as “select number 1” (step S1848). After the processor 170 identifies a valid voice command, and after the user releases the touch panel 116 (step S1849), the cloud server 150 is triggered and also requested to process the corresponding request (step S1846).

After receiving the selection of the face or the bounding box thereof by the user, the processor 170 searches for data of the corresponding person in a backend database (for example, the cloud server 150 or a local storage). Next, the processor 170 judges whether matching data is found (step S1850).

If the data is successfully found, the processor 170 generates the display content of the information image according to personal information of the person, and displays the display content on the display 114 (step S1851). The user may browse the personal information through swiping left or right on the touch panel 116 on the head-mounted device 110 (step S1852). The user may double tap the touch panel 116 (step S1853) in the personal information state to turn off the information image and return to the home screen (step S1854). On the other hand, if no corresponding data is found in the database (step S1855), the display 114 displays a pop-up message “no data found” (step S1855). After 3 seconds, the user returns to the home screen (step S1854).

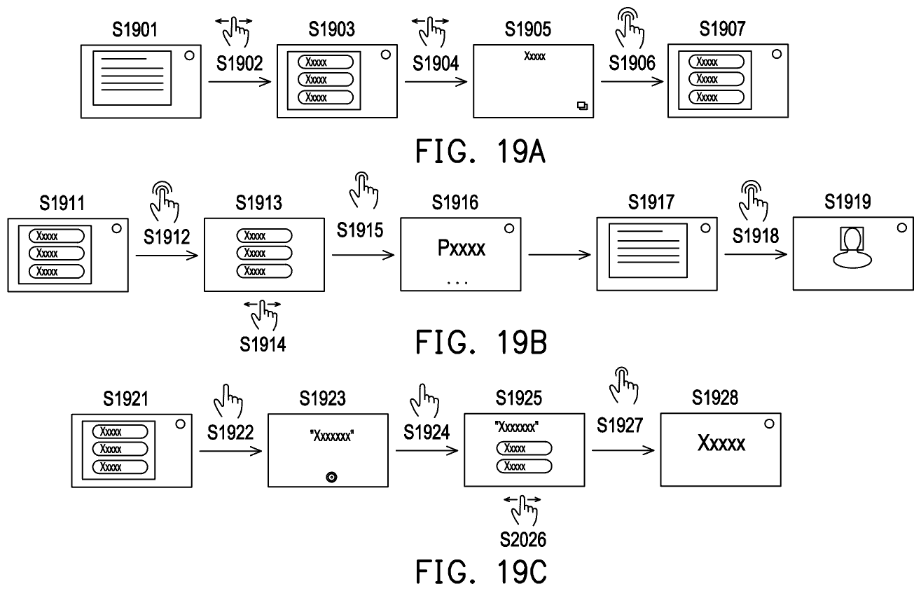

FIG. 19A to FIG. 19C are schematic diagrams of another interaction process according to an embodiment of the present invention, specifically illustrating how the user may further interact with the derived information after the personal information of the target person is displayed. Please refer to FIG. 19A. In the state of displaying personal information p1 (step S1901), the user may browse personal information p2 on other pages (step S1903) through hand gestures such as swiping left or right (step S1902).

On the page of the personal information on another page, the display 114 may provide multiple suggested interactive options, such as “show more topics” (step S1904). When the user selects the option, the display 114 pops up a window containing multiple suggested topics, such as “beach”, “castle”, and “wine tour”. The user may select one of the topics through voice or touch (step S1904). Next, the processor 170 generates more detailed conversation suggestions or derived information according to the topic (step S1905). The user may double tap the touch panel 116 in the personal information state (step S1906) to turn off the information image of the conversation suggestions or the derived information and return to the interactive option screen (step S1907).

Please refer to FIG. 19B. The process shows how to generate a conversation summary. In the state of displaying the interactive option (step S1911), the user may double tap the touch panel 116 (step S1912). The display 114 displays a pop-up window. The user may browse through swiping left or right on the touch panel 116 on the head-mounted device 110 (step S1913) and may select the option of “show summary” through tapping (step S1914). After receiving the operation command for the option, the processor 170 starts processing (step S1915), integrates past conversation records or related information with the target person into a summary text, and displays the summary text in the pop-up window (step S1916). At this time, the microphone module stops recording. After finishing browsing, the user may double tap the touch panel 116 (step S1916) to perform face search again (step S1919).

Please refer to FIG. 19C. The process shows how to trigger other application programs. In the state of displaying the interactive option (step S1921), the user may long press the touch panel 116 on the head-mounted device 110 (step S1922), so that the system enters the listening mode (step S1923). In the mode, the user may speak a voice command, such as “play some music”, to trigger a multimedia application. After receiving the command and the user releases the touch panel 116 (step S1924), the display 140 displays a pop-up message “are you sure to exit?” (step S1925). The user may finally confirm to exit the application program or select cancel to remain on the current screen. The user may browse the options through swiping left or right on the touch panel 116 on the head-mounted device 110 (step S1926) and may select the “cancel” option through tapping (step S1927). After confirmation, the user remains on the music application program screen (step S1928) and starts playing music.

In an embodiment, the processor 170 may identify a target product in the image to be detected, and generate the derived information according to the target product. The type of the target product is, for example, a handbag or a lunch box, but not limited thereto. At this time, the derived information is used for product description.

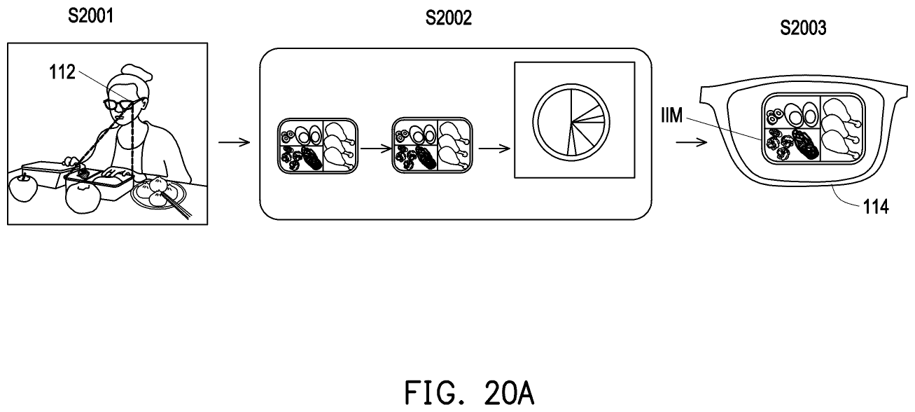

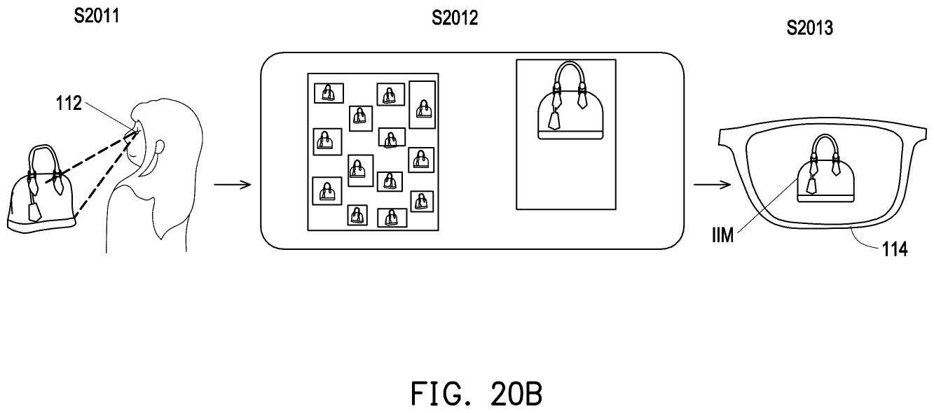

For example, FIG. 20A and FIG. 20B are schematic diagrams of a target object and a corresponding display content according to an embodiment of the present invention. Please refer to FIG. 20A. When the user looks at the lunch box (that is, the target product), the image capture device 112 captures the image to be detected of the lunch box (step S2001). After identifying a meal content (step S2002), the processor 170 may obtain nutritional information thereof from the cloud server 150 or a local database, and display the derived information such as calories (for example, 248 kcal) on the display 114 (step S2003).

Please refer to FIG. 20B. When the user looks at the handbag (that is, the target product), the image capture device 112 captures the image to be detected of the handbag (step S2011). After identifying the handbag (step S2012), the processor 170 may obtain shopping information thereof from the cloud server 150 or the local database, and display the derived information such as price and shopping platform (including shopping link) on the display 114 (step S2013).

In an embodiment, the processor 170 may identify original text information in the image to be detected, and generate the derived information according to the original text information. The language type of the original text information is, for example, English or Chinese, but not limited thereto. At this time, the derived information is used for text translation.

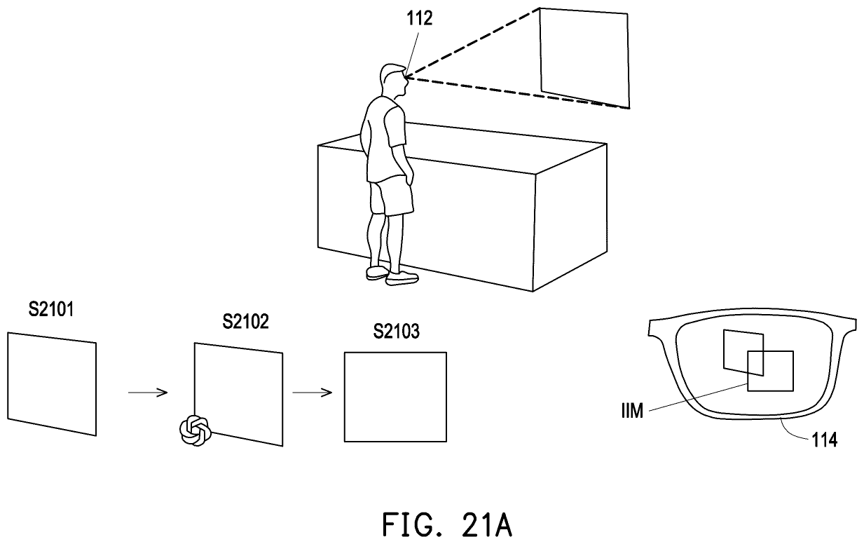

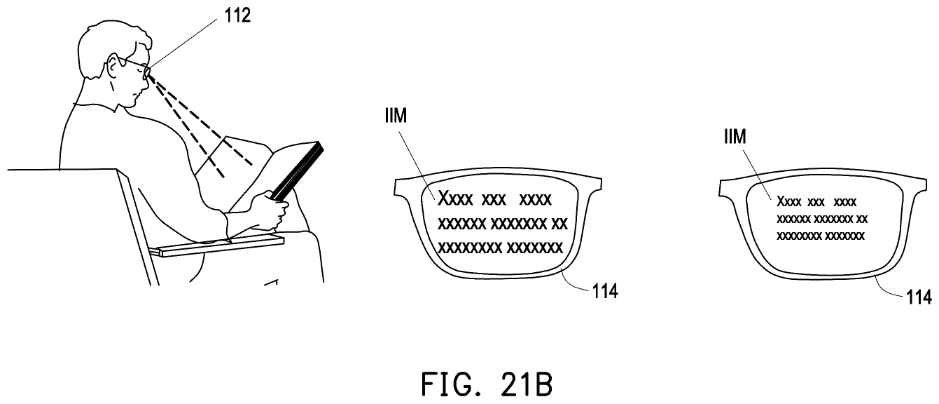

FIG. 21A and FIG. 21B are schematic diagrams of another interaction process according to an embodiment of the present invention, which illustrate the interaction process of identifying the original text information and providing translation. Please refer to FIG. 21A. When the user looks at a menu containing a foreign language, the image capture device 112 captures the image to be detected of the menu (step S2101). The processor 170 identifies the original text information in the image to be detected through optical character identification (OCR) technology (step S2102).

After identifying an original text, the processor 170 calls a translation engine to generate a translated text. The display 114 may be preset to display the original text. The user may switch the display content to the derived information after translation (the text may be arranged in a horizontal presentation format) through the hand gesture of swiping from right to left (from R to L) on the touch panel 116 (step S2103). Conversely, the user may also switch the display content back to the original text information through the hand gesture of swiping from left to right. The interactive manner allows the user to easily compare the original text with the translated text. Alternatively, the derived information may be displayed on a blank area of a translation region, and the position of the translation region may change as the posture of the head-mounted device 110 changes.

Please refer to FIG. 21B. The translation function has other extended applications. The user may save handwritten or marked note data into the application program interface, and the application program may classify the data according to time, place, and conversation participant.

For translation and note-taking applications, the user circles or underlines by hand on paper to inquire about the meaning of a slang term. For example, (context: inquire the meaning of a slang sentence) the user “tell me what's the meaning of the sentence I marked. In addition, the user requests the artificial intelligence model to provide more application example sentences, and the generated application example sentences may be added to a note database of the user. For example, the user ”give me an example sentence to let me know how Americans use it.

It should be noted that the generation of the derived information may be executed through the artificial intelligence model of the cloud server 170 or may be executed by a local model of one or more devices of the interactive control system 100. The artificial intelligence model is, for example, a large language model (LLM) or other natural language models, but not limited thereto.

In summary, the interactive control system and the interactive control method of the embodiments of the present invention establish a dual-condition trigger mechanism through combining the motion sensor and the auxiliary sensor of the head-mounted device. The mechanism can accurately judge the interaction intention of the user and only activates the image capture and information display functions when a specific combined behavior, such as “looking down at the wrist” or “turning the head to look at other targets”, is detected.

In addition, the embodiments of the present invention provide at least the following characteristics:

Virtual-reality interaction between a traditional mechanical watch and virtual reality artificial intelligence glasses.

### Meeting Record

Quick display of social information: display relevant information of people through face identification;
Instant transcript of conversation: generate transcript of conversation;
Social record aggregation: aggregate conversation records, and incorporate the conversation records into a social interaction database.

### Artificial Intelligence Object Identification

Smart identification shopping: identify products, and display product introductions and shopping links;
Smart nutritionist: identify meals for nutritional analysis and record, and provide dietary recommendations for personal health/suboptimal health conditions.

### Artificial Intelligence Translation

Artificial intelligence text image analysis (finger and hand-drawn underlining), translation of new words and phrases, artificial intelligence sentence construction, extended usage, and learning note-taking.

In this way, false triggering and power waste caused by unconscious motions are significantly reduced, and a seamless, intuitive, and instant information interactive experience may also be provided, effectively solving the issues faced by the prior art.

Although the present invention has been disclosed in the above embodiments, the embodiments are not intended to limit the present invention. Persons skilled in the art may make some changes and modifications without departing from the spirit and scope of the present invention. Therefore, the protection scope of the present invention shall be defined by the appended claims.

What is claimed is:

1. An interactive control system, comprising:
a head-mounted device, comprising:
a motion sensor, used to detect motion information;
an image capture device, used to obtain an image to be detected; and
a display, used to display an information image;
an auxiliary sensor, used to detect auxiliary information; and
a processor, communicatively connected to the head-mounted device and the auxiliary sensor, and configured to:
identify that the motion information corresponds to a target behavior, and obtain the auxiliary information according to the target behavior;
determine that the auxiliary information corresponds to a target condition, and obtain the image to be detected according to the target condition; and
identify a target object in the image to be detected, and generate a display content of the information image according to the target object.

2. The interactive control system according to claim 1, wherein the head-mounted device comprises the auxiliary sensor, the auxiliary sensor is a distance sensor, the auxiliary information is distance information, the target condition is a target depth range, and the processor is further configured to:
determine whether the distance information corresponds to the target depth range;
when the distance information corresponds to the target depth range, obtain the image to be detected through the image capture device; and
when the distance information does not correspond to the target depth range, prohibit obtaining the image to be detected.

3. The interactive control system according to claim 1, wherein the auxiliary sensor is a second motion sensor of a wearable device, the auxiliary information is second motion information, the target condition is a second target behavior, and the processor is further configured to:
determine whether the second motion information corresponds to the second target behavior;
when the second motion information corresponds to the second target behavior, obtain the image to be detected through the image capture device; and
when the second motion information does not correspond to the second target behavior, prohibit obtaining the image to be detected.

4. The interactive control system according to claim 3, wherein the processor is further configured to:
determine whether an angle value of the second motion information is within a rotation range of the second target behavior.

5. The interactive control system according to claim 1, wherein the processor is further configured to:
determine whether an angle value of the motion information is within an angle range of the target behavior;
when the angle value of the motion information is within the angle range of the target behavior, obtain the auxiliary information through the auxiliary sensor; and
when the angle value of the motion information is not within the angle range of the target behavior, prohibit obtaining the auxiliary information.

6. The interactive control system according to claim 1, wherein the processor is further configured to:
determine whether the target object is present in the image to be detected;
when the target object is present in the image to be detected, display the display content corresponding to the target object; and
when the target object is not present in the image to be detected, prohibit generating the display content of the information image.

7. The interactive control system according to claim 1, wherein the target behavior is head lowering behavior, and the display content of the information image is one of calendar information, match information, to-do information, and stock information.

8. The interactive control system according to claim 1, wherein the processor is further configured to:
identify hand gesture information of the target object in the image to be detected, wherein the target object is a hand; and
execute a target program of a reference hand gesture corresponding to the hand gesture information.

9. The interactive control system according to claim 8, wherein the target program is one of schedule browsing, missed call browsing, and unread message browsing.

10. The interactive control system according to claim 1, wherein the information image comprises derived information, and the processor is further configured to:
identify a target person in the image to be detected, and generate the derived information according to the target person and voice data, wherein the derived information is used for conversation suggestion; or
identify a target product in the image to be detected, and generate the derived information according to the target product, wherein the derived information is used for product description; or
identify original text information in the image to be detected, and generate the derived information according to the original text information, wherein the derived information is used for text translation.

11. An interactive control method, comprising:
providing a head-mounted device, an auxiliary sensor, and a processor, wherein the head-mounted device comprises a motion sensor, an image capture device, and a display;
identifying whether motion information detected by the motion sensor corresponds to a target behavior through the processor, and obtaining auxiliary information according to the target behavior through the auxiliary sensor;
determining that the auxiliary information corresponds to a target condition through the processor, and obtaining an image to be detected according to the target condition through the image capture device; and
identifying a target object in the image to be detected, and generating a display content of an information image displayed through the display according to the target object.

12. The interactive control method according to claim 11, wherein the head-mounted device comprises the auxiliary sensor, the auxiliary sensor is a distance sensor, the auxiliary information is distance information, the target condition is a target depth range, and obtaining the image to be detected according to the target condition comprises:
determining whether the distance information corresponds to the target depth range;
when the distance information corresponds to the target depth range, obtaining the image to be detected through the image capture device; and
when the distance information does not correspond to the target depth range, prohibiting obtaining the image to be detected.

13. The interactive control method according to claim 11, wherein the auxiliary sensor is a second motion sensor of a wearable device, the auxiliary information is second motion information, the target condition is a second target behavior, and obtaining the image to be detected according to the target condition comprises:
determining whether the second motion information corresponds to the second target behavior;
when the second motion information corresponds to the second target behavior, obtaining the image to be detected through the image capture device; and
when the second motion information does not correspond to the second target behavior, prohibiting obtaining the image to be detected.

14. The interactive control method according to claim 13, wherein determining whether the second motion information corresponds to the second target behavior comprises:
determining whether an angle value of the second motion information is within a rotation range of the second target behavior.

15. The interactive control method according to claim 11, wherein identifying that the motion information corresponds to the target behavior comprises:
determining whether an angle value of the motion information is within an angle range of the target behavior;
when the angle value of the motion information is within the angle range of the target behavior, obtaining the auxiliary information through the auxiliary sensor; and
when the angle value of the motion information is not within the angle range of the target behavior, prohibiting obtaining the auxiliary information.

16. The interactive control method according to claim 11, wherein generating the display content of the information image displayed through the display according to the target object comprises:
determining whether the target object is present in the image to be detected;
when the target object is present in the image to be detected, displaying the display content corresponding to the target object; and
when the target object is not present in the image to be detected, prohibiting generating the display content of the information image.

17. The interactive control method according to claim 11, wherein the target behavior is a head lowering behavior, and the display content of the information image is one of calendar information, match information, to-do information, and stock information.

18. The interactive control method according to claim 11, further comprising:
identifying hand gesture information of the target object in the image to be detected through the processor, wherein the target object is a hand; and
executing a target program of a reference hand gesture corresponding to the hand gesture information through the processor.

19. The interactive control method according to claim 18, wherein the target program is one of schedule browsing, missed call browsing, and unread message browsing.

20. The interactive control method according to claim 11, wherein the information image comprises derived information, and the interactive control method further comprises:
identifying a target person in the image to be detected through the processor, and generating the derived information according to the target person and voice data, wherein the derived information is used for conversation suggestion; or
identifying a target product in the image to be detected through the processor, and generating the derived information according to the target product, wherein the derived information is used for product description; or
identifying original text information in the image to be detected through the processor, and generating the derived information according to the original text information, wherein the derived information is used for text translation.
